(19) United States
(12) Patent Application Publication
(10) Pub. No.: US 2018/0003961 A1
(43) Pub. Date: Jan. 4, 2018

(54) GAZE DETECTION IN HEAD WORN DISPLAY

(71) Applicant: INTEL CORPORATION, SANTA CLARA, CA (US)

(72) Inventors: Eric Tremblay, Saint Sulpice (CH); Mickael Guillaumee, Neuchatel (CH); Zachary Brand, Santa Clara, CA (US)

(73) Assignee: INTEL CORPORATION, SANTA CLARA, CA (US)

(21) Appl. No.: 15/201,356

(22) Filed: Jul. 1, 2016

(51) Int. Cl. G02B 27/00; G02B 5/32; G02B 27/01

(52) U.S. Cl. CPC G02B 27/0093; G02B 27/0172; G02B 5/32; G02B 2027/0174

(57) ABSTRACT

Disclosed herein are devices and methods to determine a gaze associated with an eye. At least one infrared beam may be reflected off of the eye. The reflected infrared beam may be received and reflected from a projection surface that includes one or more layers that reflects infrared light. The projection surface may include a holographic optical element (HOE) that reflects the infrared light. The infrared beam reflected from the projection surface may be received by an infrared light beam receiver. A light intensity associated with the reflected infrared beam may be used to control one or more functionality associated with a projection system.

### TECHNICAL FIELD

Embodiments described herein generally relate to head worn displays (HWD) and heads up displays. More particularly, embodiments herein generally relate to eye gaze detection and power saving for HWD implementations. Furthermore, embodiments herein may relate to mitigating obtrusiveness associated with HWD implementations.

### BACKGROUND

Modern display technology may be implemented to provide head worn displays (HWD) and to see through the display and to see information (e.g., images, text, or the like) in conjunction with the see through display. Such displays can be implemented in a variety of contexts, for example, defense, transportation, industrial, entertainment, wearable devices, or the like.

In various HWD systems, an image may be reflected off a transparent projection surface to a user's eye to present an image in conjunction with a real worldview. HWDs provide a projection system and a lens that may include a holographic optical element (HOE). The projection system and the lens can be mounted to a frame to be worn by a user, for example, glasses, a helmet, or the like. During operation, the projection system projects an image onto an inside (e.g., proximate to the user) surface of the lens. The transparent projection surface reflects the image to an exit pupil (or viewpoint) or multiple exit pupils.

A proximity sensor may be associated with HWD systems to enable or disable one or more functionality of HWD systems. Generally, a proximity sensor adds bulk to the HWD systems. Furthermore, to allow for proper functionality, it may be necessary to place a proximity sensor in or close to a user's field of view. This may cause image viewing distractions when using HWD systems that implement a proximity sensor.

### BRIEF DESCRIPTION OF THE DRAWINGS

FIG. 1 illustrates an example first system.

FIG. 2 illustrates an example second system.

FIG. 3 illustrates a portion of the example system in more detail.

FIG. 4 illustrates an example third system.

FIG. 5A illustrates an example fourth system.

FIGS. 5B and 5C illustrate exemplary implementations of a holographic optical element (HOE).

FIG. 6 illustrates an example system or device.

FIG. 7 illustrates an example computer readable medium.

FIG. 8 illustrates an example logic flow.

### DETAILED DESCRIPTION

Various embodiments may generally be elements used with head worn displays (HWDs). HWDs may provide a projection system and a lens that includes a holographic optical element (HOE) or any other optical combining element. The projection system and the lens can be mounted to a frame to be worn by a user, for example, glasses, a helmet, or the like. During operation, the projection system projects an image onto an inside (e.g., proximate to the user) surface of the lens. The HOE reflects the image to an exit pupil (or viewpoint). Ideally, the exit pupil is proximate to one of the user's eyes, and specifically, to the pupil of the user's eye. As such, the user may perceive the reflected image.

Disclosed implementations provide an HOE the includes a surface and/or layer that reflects light in the infrared wavelength spectrum. In another implementation, the HOE includes a surface and/or layer that reflects light in the infrared wavelength spectrum and light in the visible wavelength spectrum. In yet another implementation, the HOE includes a first surface and/or layer that reflects light in the infrared wavelength spectrum, and further includes a second surface and/or layer that reflects light in the visible wavelength spectrum.

Furthermore, disclosed implementations provide devices and methods to determine a gaze associated with an eye. At least one infrared beam may be reflected off of the eye. The reflected infrared beam may be received and reflected from a projection surface that includes one or more layer that reflects infrared light. The projection surface may include an HOE that reflects the infrared light. The infrared beam reflected from the projection surface may be received by an infrared light beam receiver. A light intensity associated with the reflected infrared beam may be used to control one or more functionality associated with a projection system.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, known structures and devices are shown in block diagram form in order to facilitate a description thereof. The intention is to provide a thorough description such that all modifications, equivalents, and alternatives within the scope of the claims are sufficiently described.

Additionally, reference may be made to variables, such as, “a”, “b”, “c”, which are used to denote components where more than one component may be implemented. It is important to note, that there need not necessarily be multiple components and further, where multiple components are implemented, they need not be identical. Instead, use of variables to reference components in the figures is done for convenience and clarity of presentation.

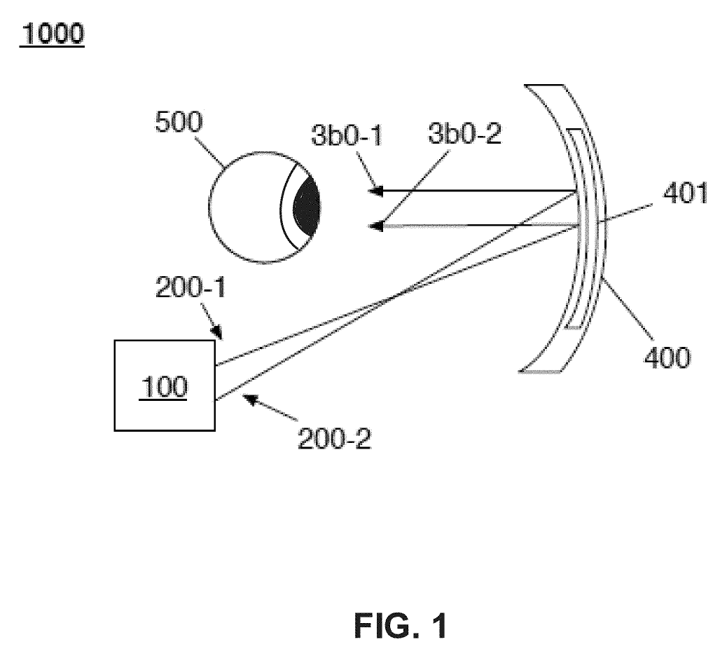

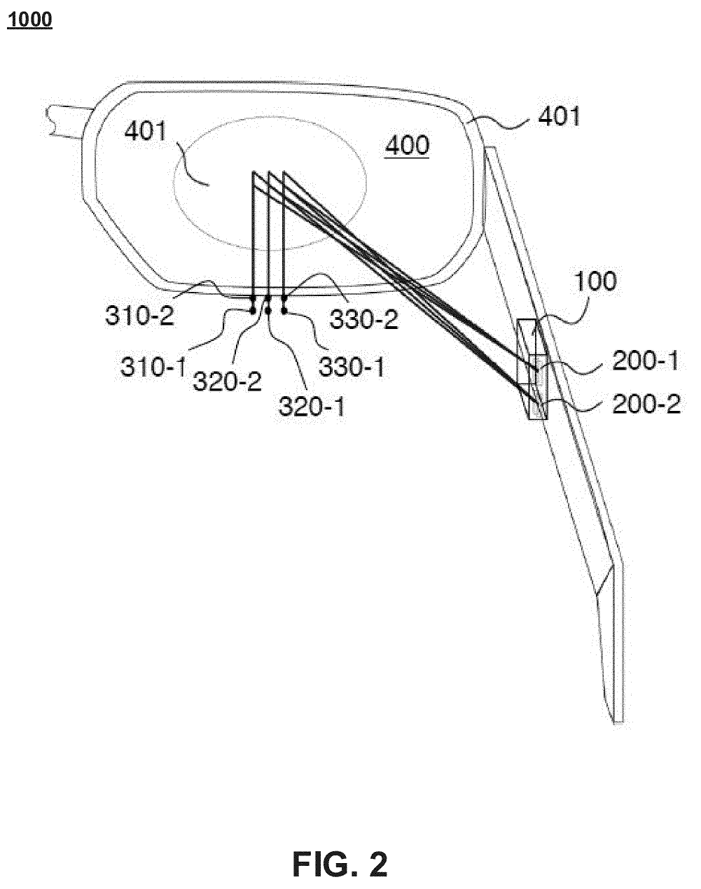

FIGS. 1-2 illustrate block diagrams of an optical system 1000 to provide multiple sets of exit pupils from multiple input pupils. It is noted, that FIG. 1 is a view of the system 1000 while FIG. 2 is a perspective view of the system.

In general, the system 1000 is configured to reflect light off a projection surface 400 to a user's eye 500. Said differently, the system 1000 projects a virtual image at exit pupils that are proximate to the user's eye 500 when a user is wearing and/or using the system 1000. In some implementations, the projection surface 400 is transparent, for example, to provide a real world view in conjunction with the projected virtual image. In some implementations, the projection surface 400 is opaque. In some implementations, the projection surface is partially transparent. It is noted, the projected virtual images can correspond to any information to be conveyed (e.g., text, images, or the like). Use of the term “virtual images” is not intended to be limiting to projection of images or pictures only. Furthermore, in some examples, the system 1000 can provide an augmented reality display where portions of the real world (e.g., either viewed through the display or projected) are augmented with virtual images. Examples are not limited in this context.

In general, the system 1000 is configured to create multiple sets of spatially separated exit pupils at the eye 500 of the user of the system 1000 (or location where the eye should be or would be if the system 1000 were worn or used). However, the system 100 may also be configured to create a single exit pupil at the eye 500 of the user of the system 1000. Sets of spatially separated exit pupils form an enlarged “synthetic” eyebox. As such, a larger field of view or larger projected image may be provided by the system 1000. In addition to providing a larger field of view, the enlarged eyebox may account for both person-to-person anthropometric differences in eye location, and the rotation of a user's eye as the user explores the projected image. It is noted, in some examples, the system 1000 can provide an enlarged field of view to provide a larger projected virtual image. In some examples, the system 1000 can provide an enlarged field of view to provide multiple copies of a projected virtual image such that a user can perceive the projected virtual image as the user rotates the eye. Examples are not limited in this context.

The system 1000 may include a projection system 100 to project light to form multiple entrance pupils 200-a, where a is a positive integer. In another implementation, the projection system 100 projects light to form a single entrance pupil. Light beams corresponding to entrance pupils 200-1 and 200-2 are depicted. Each of the light beams corresponding to the entrance pupils 200-a is wavelength-multiplexed to form multiple exit pupils 3b0-b for each entrance pupil, where b is a positive integer. As such, multiple sets of exit pupils are formed (e.g., one set for each entrance pupil 200-a). In another implementation, a single entrance pupil corresponds to a single exit pupil. Therefore, another embodiment may provide multiple entrance pupils, where each of the multiple entrance pupils corresponds to a single exit pupil. Wavelength multiplexing is not required in such an embodiment.

More specifically, the projection system 100 can project light from multiple entrance pupils 200-a to the projection surface 400. For example, the projection system can project light from entrance pupils 200-1 and 200-2 to the projection surface 400. Each entrance pupil 200-a includes multiple light beams, each having a different wavelength. The projection surface 400 reflects these wavelength multiplexed light beams to a first set of exit pupils 3b0-a. For example, the projection surface 400 can reflect the light beams from the entrance pupil 200-1 to the set of exit pupils 3b0-1 and the light beams from the entrance pupil 200-2 to the set of exit pupils 3b0-2. In particular, as depicted in FIG. 2, the projection surface 400 reflects light from entrance pupil 200-1 to exit pupils 310-1, 320-1, and 330-1. Additionally, the projection surface 400 reflects light from entrance pupil 200-2 to exit pupils 310-2, 320-2, and 330-2. Examples are not limited in this context.

In some implementations, each entrance pupil 200-a can correspond to a number of wavelength multiplexed light beams in a range of wavelengths. More specifically, the projection system 100 can project an input beam (e.g., 200-1, 200-2, or the like) including multiple groups of light, each group having a wavelength similar in perceived color (e.g., λ₁, λ₂, and λ₃) to the projection surface 400. Furthermore, the projection system 100 directs these wavelength-multiplexed light to the projection surface 400 from multiple spatially separated points.

In general, the projection surface 400 includes a number of independent, multiplexed gratings (e.g., Bragg gratings, or the like) recorded in it. The projection surface can be referred to as an HOE or a volume hologram. The projection surface 400 is wavelength selective, in that it reflects all (or at least part of) the light from a first wavelength (e.g., λ₁, first group of wavelengths, first range of wavelengths, or the like) to a first exit pupil location. The projection surface 400 reflects all (or at least part of) the light from a second wavelength (e.g., λ₂, second group of wavelengths, second range of wavelengths, or the like) to a second exit pupil location. The projection surface 400 reflects all (or at least part of) the light from a third wavelength (e.g., λ₃, third group of wavelengths, third range of wavelengths, or the like) to a third exit pupil location. These exit pupil locations are spatially separated from each other. Examples are not limited in this context.

In one implementation, the projection surface 400 is an HOE or at least comprises an HOE. The HOE may be manufactured to reflect one or more light beam having a wavelength property that is within the infrared light range. Alternatively, the HOE may be manufactured to reflect one or more light beam having a wavelength property that is substantially within the infrared wavelength range. Near infrared light has a wavelength range of 760 nm-1400 nm. Comparatively, visible light wavelength range is 400 nm-760 nm. In one implementation, the HOE may be manufactured to reflect one or more light beam having a wavelength property that is substantially within the infrared wavelength range. Furthermore, the same HOE may be manufactured to reflect one or more light beam having a wavelength property that is substantially in the visible wavelength range. Examples are not limited in this context.

In one example implementation, the projection surface 400 includes an HOE (e.g., an HOE 401) that comprises at least two distinct surfaces or layers. The at least two distinct surfaces or layers may be situated in a stacked arrangement or in a side-by-side arrangement. A first of the at least two distinct surfaces or layers is manufactured to reflect one or more light beam having a wavelength property that is substantially in the visible wavelength range. A second of the at least two distinct surfaces or layers is manufactured to reflect one or more light beam in the infrared wavelength range. In another example implementation, the projection surface 400 includes an HOE that comprises at least one layer. The at least one layer is manufactured to reflect one or more light beam having a wavelength property that is substantially in the visible wavelength range. Furthermore, the at least one layer is manufactured to reflect one or more light beam in the infrared wavelength range.

In one example implementation, the projection surface 400 includes an HOE that comprises at least two distinct surfaces or layers, where one or both of the two distinct surfaces or layers is a photopolymer. A first of the at least two distinct surfaces or layers is manufactured to reflect one or more light beam having a wavelength property that is substantially in the visible wavelength range. Therefore, first of the at least two distinct surfaces or layers is at least wavelength tuned to light in the visible wavelength spectrum. A second of the at least two distinct surfaces or layers is manufactured to reflect one or more light beam in the infrared wavelength range. Therefore, the second of the at least two distinct surfaces or layers is at least wavelength tuned to light in the infrared wavelength spectrum. In another example implementation, the projection surface 400 includes an HOE that comprises at least one layer. The at least one layer is a photopolymer. The at least one layer is manufactured to reflect one or more light beam having a wavelength property that is substantially in the visible wavelength range. Furthermore, the at least one layer is manufactured to reflect one or more light beam in the infrared wavelength range. Therefore, the at least one layer that is the photopolymer is at least wavelength tuned to light in the visible wavelength spectrum and is further at least wavelength tuned to light in the infrared wavelength spectrum.

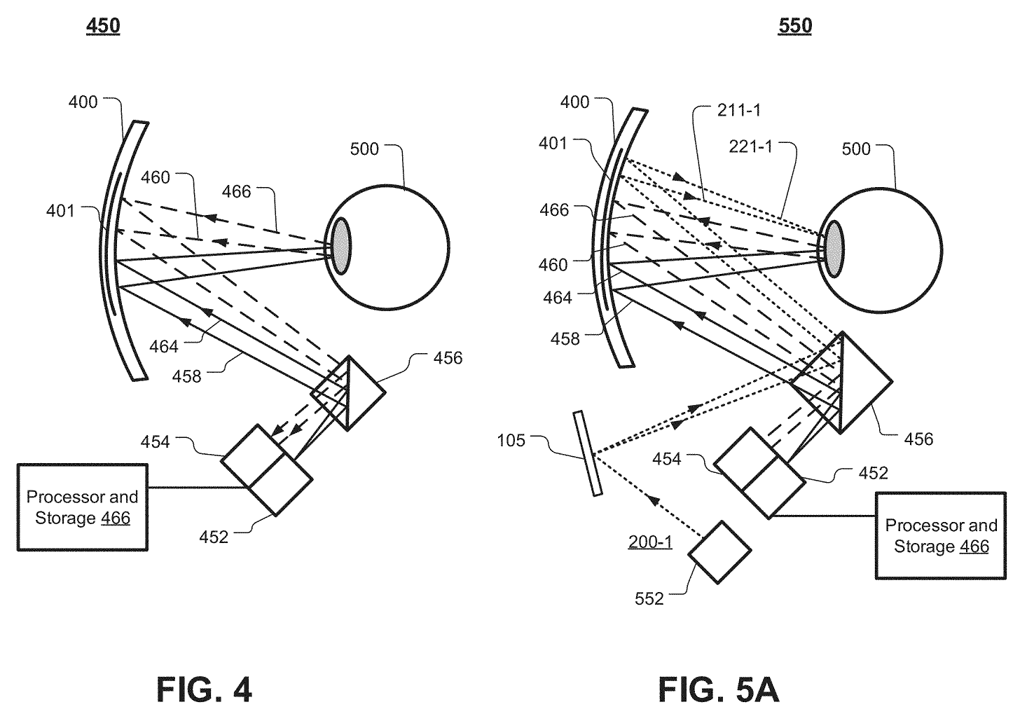

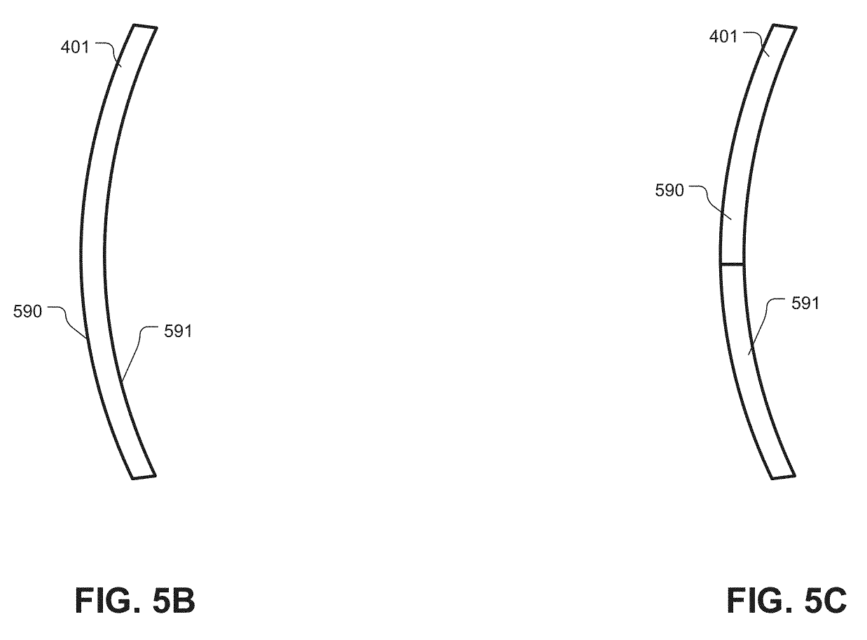

A projection surface that includes an HOE of the types described in the foregoing, is covered in greater detail in the following, and particularly with reference to FIGS. 4-5.

FIG. 2 depicts columns of exit pupils 3b0-a. In particular, a first column of exit pupils, which may correspond to a first wavelength can include exit pupils 310-1 and 310-2. A second column of exit pupils, which may correspond to a second wavelength can include exit pupils 320-1 and 320-2. A third column of exit pupils, which may correspond to a third wavelength can include exit pupils 330-1 and 330-2. Accordingly, the six exit pupils 310-1, 310-2, 320-1, 320-2, 330-1, and 330-2 are depicted. In this example, the three wavelengths at which each input pupil are multiplexed act to spatially separate the exit pupils in the horizontal direction (3 across) with 3 multiplexed HOEs 401 on or in the surface 400. The two entrance pupils 200-1 and 200-2 are used to create two rows of exit pupil. In particular, the leftmost column of the 3×2 exit pupil array would correspond to a single wavelength (λ₁) of light from two vertically offset sources. Similarly, for the middle column (λ₂ from two vertically offset sources) and right-most column (λ₃ from two vertically offset sources). Examples are not limited in this context.

Each of the entrance pupils are angularly separated from each other. It is noted, that HOE can be selective in angle and wavelength, however this property depends heavily on the orientation. In particular, such holograms can be highly selective in the plane perpendicular to the gratings (e.g., the Bragg direction, or the like). However, such holograms may be much less selective in the orthogonal or “out-of-plane” direction. Accordingly, the multiple entrance pupils are offset in the vertical direction of FIGS. 1-2 while the grating of the surface 400 is setup in the horizontal direction. It is noted, that the grating may be configured to wavelength multiplex the light either vertically or horizontally. As such, the entrance pupils may be either horizontally or vertically separated. It is worthy to note, the chief ray of the exit pupils 310-b corresponding to one entrance pupil 200-1 may not need to be aligned in a “line” as depicted in FIGS. 1-2. Examples are not limited in this respect. Examples are not limited in this context.

The projection system 100 projects light onto the projection surface 400 from the entrance pupils 200-a. In particular, the projection system 100 projects the light onto a portion of the projection surface 400 that includes the HOE 401. The HOE 401 reflects the incident light to multiple exit pupils 3b0-a to (or into) a user's eye 500 so a virtual image can be perceived by the user. Examples are not limited in this context.

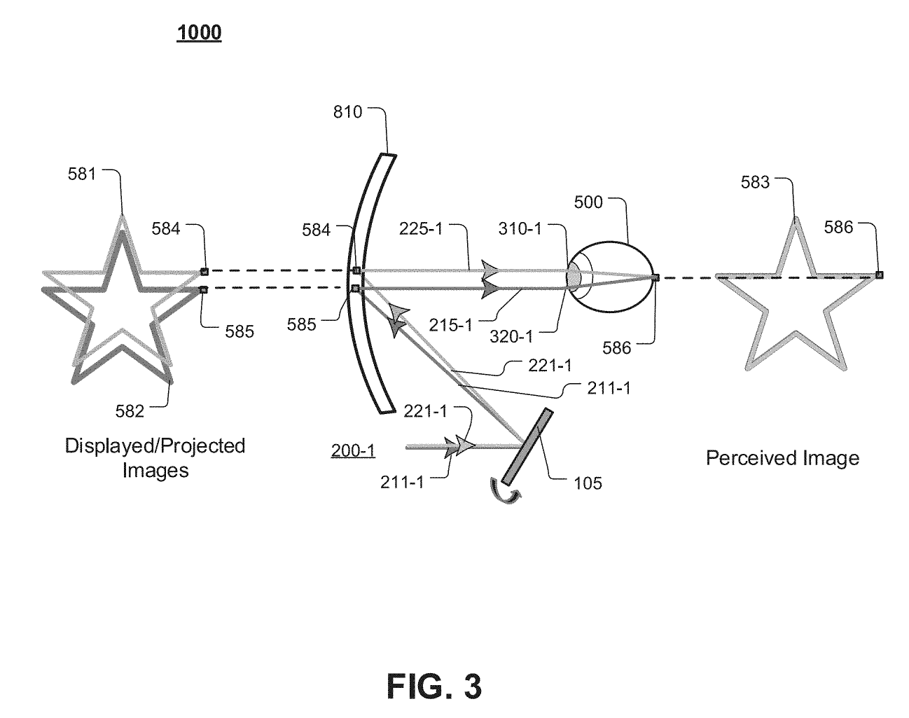

FIG. 3 depicts the scanning mirror 105 reflecting light beams 211-1 and 221-1 from entrance pupil 200-1. The light beams 211-1 and 221-1 can have different wavelengths as described above. The scanning mirror 105 reflects the light beams 211-1 and 221-1 to the projection surface 400, which includes a HOE to reflect the light beams to different exit pupils. The scanning mirror 105 (or other component of the projection system 100) can modulate the light beams 211-1 and 221-1 to correspond to images 581 and 582. By projecting images 581 and 582 shifted from each other as depicted, a single apparent image 583 can be produced on the retina of the eye 500. More specifically, a single image can be perceived by a user. Examples are not limited in this context.

In particular, the pixels 584 and 585 contain the information of the same image pixel for each exit pupil 310-1 and 320-1. By projecting pixels 584 and 585 on the projection surface with a separation distance similar to the separation distance of the exit pupils 310-1 and 320-1, pixels 584 and 585 are reflected by the projection surface 400 as diffracted light beams 215-1 and 225-1 to exit pupils 310-1 and 320-1, respectively. Additionally, the pixels 584 and 585 merge into one single pixel 586 on the retina of the eye 500 so the images 581 and 582 are perceived as a single image 583. This is true even when the eye 500 is rotated so the line of sight other than that illustrated in FIG. 3. Examples are not limited in this context.

In some examples, the light beams 211-1 and 221-1 are modulated based on image processing techniques to laterally shift the projected images for each of the different wavelength sources. Additional geometric corrections may be applied, for example, to correct for distortion. Furthermore, additional pre-processing of the images to correct nonlinearities (e.g., distortion, or the like) to improve alignment of the images may be implemented.

In some examples, multiple sets of light beams may be reflected off of the scanning mirror 105 to generate additional diffracted light beams, pixels, and corresponding exit pupils. Examples are not limited in this context.

In general, the projection system 100 can receive a beam of light from a laser or may include a laser to generate light beams having different wavelengths. The projection system 100 can include a micro-electro-mechanical system (MEMS) mirror to scan and/or direct the light across the projection surface 400 from multiple viewpoints (e.g., entrance pupils). Examples are not limited in this context.

With some examples, the projection surface 400 may be a volume holographic transflector. As noted, the projection surface 400 may reflect the light projected by the system 100 into the eye 500 to provide a virtual image in the synthetic eyebox. Additionally, the projection surface 400 can simultaneously allow light from outside the system 1000 (e.g., real world light, etc.) to be transmitted through the projection surface 400 to provide for a real world view in addition to a virtual view. Examples are not limited in this context.

In general, the system 1000 may be implemented in any heads up and/or head worn display. With some examples, the projection surface 400 may be implemented in a wearable device, such as for example, glasses 401. Although glasses are depicted, the system 1000 can be implemented in a helmet, visor, windshield, or other type of HUD/HWD display. Examples are not limited in this context.

Furthermore, additional sets of exit pupils can be created, for example, 3 entrance pupils each multiplexed with three wavelengths may form 9 exit pupils in a 3×3 array. Examples are not limited in this context.

FIG. 4 illustrates a projection system 450. The projection system 450 includes the projection surface 400 that incorporates the HOE 401. The projection surface 400 may be, for example, implemented as described in the foregoing. In one implementation, the projection system 450 may be coupled to an HWD and the various systems associated with HWD, including a power supply for the HWD.

The projection system 450 may include an infrared light beam emitter 452 and an infrared light beam receiver 454. The infrared light beam emitter 452 and the infrared light beam receiver 454 may be an integrated unit. The projection system 450 may further include an optical element 456. The optical element 456 may be functional to direct (e.g., reflect, diffract, fold, and/or the like) light beams to the projection surface 400. In one implementation, the optical element 456 comprises a beam splitter. Examples are not limited in this context.

The infrared light beam emitter 452 may generate and transmit at least one infrared light beam 458. The at least one infrared light beam 458 may be directed to the projection surface 400 by the optical element 456. The HOE 401 reflects the at least one infrared light beam 458 toward the eye 500. In one implementation, the HOE 401 reflects the at least one infrared light beam 458 toward an exit pupil associated with the eye 500. The eye 500 reflects a portion of the at least one infrared light beam 458 back to the projection system 450. This reflected portion of the at least one infrared light beam 458 is shown as at least one reflected infrared light beam 460. The at least one reflected infrared light beam 460 may be reflected from the retina, iris, sclera or skin (e.g., eyelid) of the eye 500. Examples are not limited in this context.

The HOE 401 reflects the at least one reflected infrared light beam 460 toward the optical element 456. The optical element 456 receives and directs the at least one reflected infrared light beam 460 toward the infrared light beam receiver 454. The at least one reflected infrared light beam 460 is received by the infrared light beam receiver 454. Examples are not limited in this context.

The projection system 450 may furthermore generate and transmit another at least one infrared light beam 464 by way of the infrared light beam emitter 452. The another at least one infrared light beam 464 may be directed to the projection surface 400 by the optical element 456. The HOE 401 reflects the another at least one infrared light beam 464 toward the eye 500. In one implementation, the HOE 401 reflects the another at least one infrared light beam 464 toward an exit pupil associated with the eye 500. The eye 500 reflects a portion of the another at least one infrared light beam 464 back to the projection system 450. This reflected portion of the another at least one infrared light beam 464 is shown as another at least one reflected infrared light beam 466. The another at least one reflected infrared light beam 466 may be reflected from the retina, iris, sclera or skin (e.g., eyelid) of the eye 500. Examples are not limited in this context.

The HOE 401 reflects the another at least one reflected infrared light beam 466 toward the optical element 456. The optical element 456 receives and directs the another at least one reflected infrared light beam 466 toward the infrared light beam receiver 454. The another at least one reflected infrared light beam 466 is received by the infrared light beam receiver 454. Examples are not limited in this context.

In the foregoing, use of a plurality of infrared light beams and reflected light beams may increase the eye gaze sensitivity of the projection system 450. Specifically, spatially separated exit pupils may increase the eye gaze sensitivity the projection system 450. Examples are not limited in this context.

A light intensity associated with the at least one reflected infrared light beam 460 will vary depending on a surface that the at least one infrared light beam 458 was reflected from. For example, the at least one reflected infrared light beam 460 will have a first light intensity when it reflects off the retina of the eye 500. The at least one reflected infrared light beam 460 will have a second light intensity when it reflects off skin, such as the eyelid of the eye 500. The at least one reflected infrared light beam 460 will have a third light intensity when it reflects off the sclera of the eye 500. And the at least one reflected infrared light beam 460 will have a fourth light intensity when reflects off the iris of the eye 500. Examples are not limited in this context.

Similarly, a light intensity associated with the another at least one reflected infrared light beam 466 will vary depending on a surface that the another at least one infrared light beam 464 was reflected from. For example, the another at least one reflected infrared light beam 466 will have a first light intensity when it reflects off the retina of the eye 500. The at least one reflected infrared light beam 466 will have a second light intensity when it reflects off skin, such as the eyelid of the eye 500. The another at least one reflected infrared light beam 466 will have a third light intensity when it reflects off the sclera of the eye 500. And the another at least one reflected infrared light beam 466 will have a fourth light intensity when reflects off the iris of the eye 500.

A processor and storage arrangement 466 may be coupled to the projection system 450. The storage of the arrangement 466 may include computer executable instructions. The computer executable instructions may be executed by the processor of the arrangement 466.

The processor and storage arrangement 466 may receive reflected light intensity information from the infrared light beam receiver 454. The processor and storage arrangement 466 may use the received reflected light intensity information to change an operating condition of the HWD. For example, in one implementation, the third light intensity information (e.g., from beams 460 and/or 466) may indicate that a gaze of the eye 500 has turned away from the projection surface 400. In one implementation, the processor and storage arrangement 466 may compare the third light intensity information with predetermined light intensity information to ascertain that the gaze of the eye 500 has turned away from the projection surface 400. The processor of the processor and storage arrangement 466 may execute computer executable instructions of the storage to suspend power to the HWD based on receiving the third light intensity information. The examples are not limited in this context.

The processor and storage arrangement 466 may be functional to convert received reflected light intensity information into a derived signal type. For example, the processor and storage arrangement 466 may convert received reflected light intensity information into one or more voltage. The one or more voltage may be compared to a predetermined one or more voltage to ascertain a gaze of the eye 500.

FIG. 5A illustrates a projection system 550. The projection system 550 includes the projection surface 400 that incorporates the HOE 401. The projection surface 400 may be, for example, implemented as described in the foregoing. In one implementation, the projection system 550 may be coupled to an HWD and the various systems associated with HWD, including a power supply for the HWD.

The projection system 550 may include the infrared light beam emitter 452 and the infrared light beam receiver 454. The infrared light beam emitter 452 and the infrared light beam receiver 454 may be an integrated unit. The projection system 550 may further include the optical element 456. The optical element 456 may be functional to direct (e.g., reflect, diffract, fold, and/or the like) light beams to the projection surface 400. In one implementation, the optical element 456 comprises a beam splitter. Examples are not limited in this context.

The infrared light beam emitter 452 may generate and transmit the at least one infrared light beam 458. The at least one infrared light beam 458 may be directed to the projection surface 400 by the optical element 456. The HOE 401 reflects the at least one infrared light beam 458 toward the eye 500. In one implementation, the HOE 401 reflects the at least one infrared light beam 458 toward an exit pupil associated with the eye 500. The eye 500 reflects a portion of the at least one infrared light beam 458 back to the projection system 550. This reflected portion of the at least one infrared light beam 458 is shown as the at least one reflected infrared light beam 460. The at least one reflected infrared light beam 460 may be reflected from the retina, iris, sclera or skin (e.g., eyelid) of the eye 500. Examples are not limited in this context.

The HOE 401 reflects the at least one reflected infrared light beam 460 toward the optical element 456. The optical element 456 receives and directs the at least one reflected infrared light beam 460 toward the infrared light beam receiver 454. The at least one reflected infrared light beam 460 is received by the infrared light beam receiver 454. Examples are not limited in this context.

The projection system 550 may furthermore generate and transmit the another at least one infrared light beam 464 by way of the infrared light beam emitter 452. The another at least one infrared light beam 464 may be directed to the projection surface 400 by the optical element 456. The HOE 401 reflects the another at least one infrared light beam 464 toward the eye 500. In one implementation, the HOE 401 reflects the another at least one infrared light beam 464 toward an exit pupil associated with the eye 500. The eye 500 reflects a portion of the another at least one infrared light beam 464 back to the projection system 550. This reflected portion of the another at least one infrared light beam 464 is shown as the another at least one reflected infrared light beam 466. The another at least one reflected infrared light beam 466 may be reflected from the retina, iris, sclera or skin (e.g., eyelid) of the eye 500. Examples are not limited in this context.

The HOE 401 reflects the another at least one reflected infrared light beam 466 toward the optical element 456. The optical element 456 receives and directs the another at least one reflected infrared light beam 466 toward the infrared light beam receiver 454. The another at least one reflected infrared light beam 466 is received by the infrared light beam receiver 454. Examples are not limited in this context.

In the foregoing, use of a plurality of infrared light beams and reflected light beams may increase the eye gaze sensitivity of the projection system 550. Specifically, spatially separated exit pupils may increase the eye gaze sensitivity the projection system 550. Examples are not limited in this context.

A light intensity associated with the at least one reflected infrared light beam 460 will vary depending on a surface that the at least one infrared light beam 458 was reflected from. For example, the at least one reflected infrared light beam 460 will have a first light intensity when it reflects off the retina of the eye 500. The at least one reflected infrared light beam 460 will have a second light intensity when it reflects off skin, such as the eyelid of the eye 500. The at least one reflected infrared light beam 460 will have a third light intensity when it reflects off the sclera of the eye 500. And the at least one reflected infrared light beam 460 will have a fourth light intensity when reflects off the iris of the eye 500. Examples are not limited in this context.

Similarly, a light intensity associated with the another at least one reflected infrared light beam 466 will vary depending on a surface that the another at least one infrared light beam 464 was reflected from. For example, the another at least one reflected infrared light beam 466 will have a first light intensity when it reflects off the retina of the eye 500. The at least one reflected infrared light beam 466 will have a second light intensity when it reflects off skin, such as the eyelid of the eye 500. The another at least one reflected infrared light beam 466 will have a third light intensity when it reflects off the sclera of the eye 500. And the another at least one reflected infrared light beam 466 will have a fourth light intensity when reflects off the iris of the eye 500.

A processor and storage arrangement 466 may be coupled to the projection system 550. The storage of the arrangement 466 may include computer executable instructions. The computer executable instructions may be executed by the processor of the arrangement 466.

The processor and storage arrangement 466 may receive reflected light intensity information from the infrared light beam receiver 454. The processor and storage arrangement 466 may use the received reflected light intensity information to change an operating condition of the HWD. For example, in one implementation, the third light intensity information (e.g., from beams 460 and/or 466) may indicate that a gaze of the eye 500 has turned away from the projection surface 400. In one implementation, the processor and storage arrangement 466 may compare the third light intensity information with predetermined light intensity information to ascertain that the gaze of the eye 500 has turned away from the projection surface 400. The processor of the processor and storage arrangement 466 may execute computer executable instructions of the storage to suspend power to the HWD based on receiving the third light intensity information. The examples are not limited in this context.

The processor and storage arrangement 466 may be functional to convert received reflected light intensity information into a derived signal type. For example, the processor and storage arrangement 466 may convert received reflected light intensity information into one or more voltage. The one or more voltage may be compared to a predetermined one or more voltage to ascertain a gaze of the eye 500.

The implementation illustrated in FIG. 5A also includes the scanning mirror 105 that reflects light beams 211-1 and 221-1 from input pupil 200-1. The light beams 211-1 and 221-1 may be generated by a light source 552. In some examples, the light beams 211-1 and 221-1 are modulated based on image processing techniques to laterally shift the projected images for each of the different wavelength sources. Additional geometric corrections may be applied, for example, to correct for distortion. The present disclosure may provide systems having additional shifts across 2-dimensions. Furthermore, additional pre-processing of the images to correct nonlinearities (e.g., distortion, or the like) to improve alignment of the images may be implemented. The number of light beams is exemplary. The examples are not limited in this context.

Although covered in the foregoing, it is worth noting here that in one implementation, the projection surface 400 is an HOE or at least comprises an HOE (e.g., the HOE 401). The HOE may be manufactured to reflect one or more light beam having a wavelength property that is within the infrared range. Alternatively, the HOE may be manufactured to reflect one or more light beam having a wavelength property that is substantially within the infrared wavelength range. Near infrared light has a wavelength range of 760 nm-1400 nm. Comparatively, visible light wavelength range is 400 nm-760 nm. In one implementation, the HOE may be manufactured to reflect one or more light beam having a wavelength property that is substantially within the infrared wavelength range. Furthermore, the same HOE may be manufactured to reflect one or more light beam having a wavelength property that is substantially in the visible wavelength range. Examples are not limited in this context.

FIGS. 5B and 5C illustrate exemplary implementations of the HOE 401. In one example implementation, the projection surface 400 includes the HOE 401 that comprises at least two distinct surfaces or layers 590 and 591. The at least two distinct surfaces or layers 590 and 591 may be situated in a stacked arrangement (FIG. 5B) or in a side-by-side arrangement (FIG. 5C). A first of the at least two distinct surfaces or layers (590 or 591) is manufactured to reflect one or more light beam having a wavelength property that is substantially in the visible wavelength range. A second of the at least two distinct surfaces or layers (590 or 591) is manufactured to reflect one or more light beam in the infrared wavelength range.

In another example implementation, the projection surface 400 includes the HOE 401 that comprises at least one layer. The at least one layer is manufactured to reflect one or more light beam having a wavelength property that is substantially in the visible wavelength range. Furthermore, the same at least one layer is manufactured to reflect one or more light beam in the infrared wavelength range.

In one example implementation, the projection surface 400 includes the HOE 401 that comprises at least two distinct surfaces or layers 590 and 591, where one or both of the two distinct surfaces or layers is a photopolymer. A first of the at least two distinct surfaces or layers (590 or 591) is manufactured to reflect one or more light beam having a wavelength property that is substantially in the visible wavelength range. Therefore, the first of the at least two distinct surfaces or layers (590 or 591) is at least wavelength tuned to light in the visible wavelength spectrum. A second of the at least two distinct surfaces or layers (590 or 591) is manufactured to reflect one or more light beam in the infrared wavelength range. Therefore, the second of the at least two distinct surfaces or layers (590 or 591) is at least wavelength tuned to light in the infrared wavelength spectrum.

In another example implementation, the projection surface 400 includes the HOE 401 that comprises at least one layer. The at least one layer is a photopolymer. The at least one layer is manufactured to reflect one or more light beam having a wavelength property that is substantially in the visible wavelength range. Furthermore, the same at least one layer is manufactured to reflect one or more light beam in the infrared wavelength range. Therefore, the at least one layer that is the photopolymer is at least wavelength tuned to light in the visible wavelength spectrum and is further at least wavelength tuned to light in the infrared wavelength spectrum.

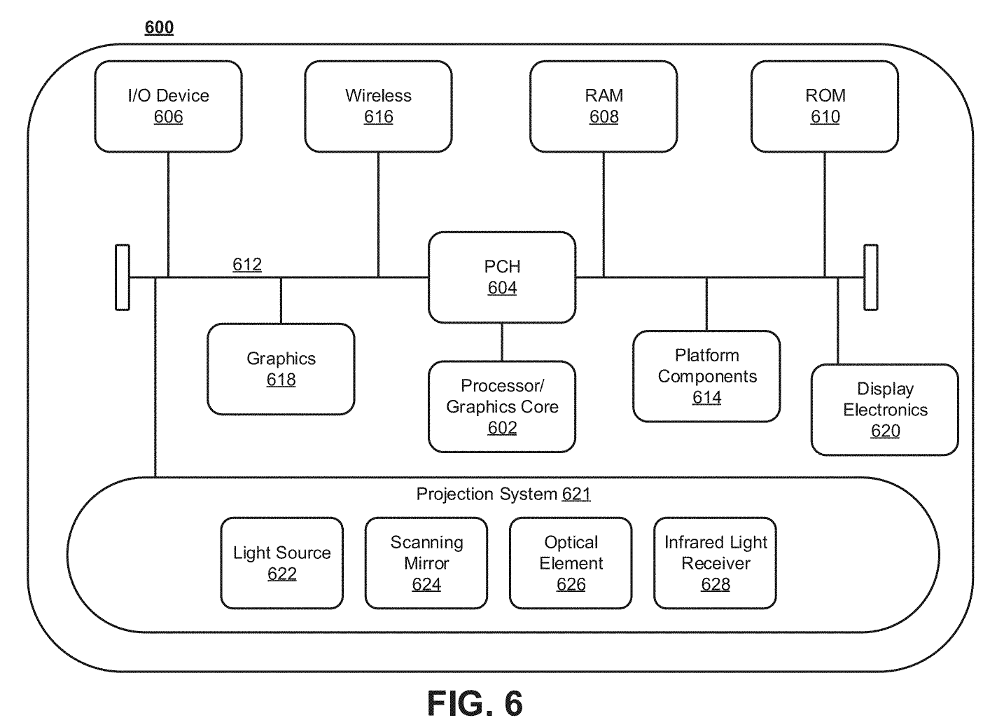

FIG. 6 depicts that a platform (system) 600 may include a processor/graphics core 602, a chipset/platform control hub (PCH) 604, an input/output (I/O) device 606, a random access memory (RAM) (such as dynamic RAM (DRAM)) 608, and a read only memory (ROM) 610, display electronics 620, projection system 621 (e.g., the projection systems 100, 450, 550), and various other platform components 614 (e.g., a fan, a cross flow blower, a heat sink, DTM system, cooling system, housing, vents, and so forth). System 600 may also include wireless communications chip 616 and graphics device 618. The embodiments, however, are not limited to these elements. The system 600 may be coupled to the systems 100, 1000, 450, and/or 550 and/or implemented by the system 1000. Examples are not limited in this context.

As depicted, I/O device 706, RAM 608, and ROM 610 are coupled to processor 600 to by way of chipset 604. Chipset 604 may be coupled to processor 602 by a bus 612. Accordingly, bus 612 may include multiple lines.

Processor 602 may be a central processing unit comprising one or more processor cores and may include any number of processors having any number of processor cores. The processor 602 may include any type of processing unit, such as, for example, CPU, multi-processing unit, a reduced instruction set computer (RISC), a processor that have a pipeline, a complex instruction set computer (CISC), digital signal processor (DSP), and so forth. In some embodiments, processor 602 may be multiple separate processors located on separate integrated circuit chips. In some embodiments processor 602 may be a processor having integrated graphics, while in other embodiments processor 602 may be a graphics core or cores. Examples are not limited in this context.

The projection system 621 may include various elements that aid in providing light as part of generating pixels (e.g., pixels 584 and 585). The elements of the projection system 621 may be controlled by a controller, such as the processor/graphics core 602. The projection system 621 may include one or more light source 622, one or more scanning mirror 624, one or more optical element 626, and an infrared light receiver 628. In general, the light source 622 generates light having multiple light beams (e.g., light beams 211-1 and 221-1 from entrance pupil 200-1).

Furthermore, the light source 622 may generate infrared light beams (e.g., infrared light beams 460 and 466). The light source 622 may be a single light source that is capable of generating light beams in the visible light wavelength spectrum and the infrared light wavelength spectrum. Alternatively, the light source 622 may be disparate light sources. A first of the disparate light sources generates light beams in the visible light wavelength spectrum and a second of the disparate light sources generates light beams in the infrared light wavelength spectrum.

The light beams emitted from the light source 622 may be received by the one or more scanning mirror 624. The one or more scanning mirror 624 may project the light beams to an optical element 626. The optical element 626 directs (e.g. reflects, diffracts, folds, and/or the like) the light beams to a projection surface (e.g. the projection surface 400 and/or HOE 401) from one or more entrance pupil. For example, the optical element 626 may direct light beams 211-1 and 221-1 from entrance pupil 200-1. Furthermore, the optical element 626 may direct infrared light beams 460 and 466 from the light source 622. Furthermore, the optical element 662 may direct reflected infrared light beams (e.g., reflected infrared light beams 460 and 466). In one example, the optical element 662 directs reflected infrared light beams to the infrared light receiver 628. Examples are not limited in this context.

In one implementation, reflected infrared light beams received by the infrared light receiver 628 may cause the system 600 to alter its operational state. For example, if the reflected infrared light beams received by the infrared light receiver 628 indicate that a gaze of the eye 500 is not focused on the projection surface 400 and/or the HOE 401, the processor 602 in conjunction with executable instructions stored in the RAM 608 and/or ROM 610 may reduce or eliminate power supplied to one or more elements of the system 600 and/or elements coupled to the system 600. In one example, a determination that the eye 500 is not focused on the projection surface 400 and/or the HOE 401 may result in reduction or elimination of power to the light source 622, the scanning mirror 624, the optical element 626, and/or the infrared light receiver 628. In another example, a determination that the eye 500 is not focused on the projection surface 400 and/or the HOE 401 may result in a reduction or elimination of power to the projection surface 400 and/or the HOE 401. Examples are not limited in this context.

In another implementation, if the reflected infrared light beams received by the infrared light receiver 628 indicate that a gaze of the eye 500 is focused on the projection surface 400 and/or the HOE 401, the processor 602 in conjunction with executable instructions stored in the RAM 608 and/or ROM 610 may provide or increase power supplied to one or more elements of the system 600 and/or elements coupled to the system 600. In another example, a determination that the eye 500 is focused on the projection surface 404 and/or the HOE 401 may result in an increase of power to the light source 622, the scanning mirror 624, the optical element 626, and/or the infrared light receiver 628. Examples are not limited in this context.

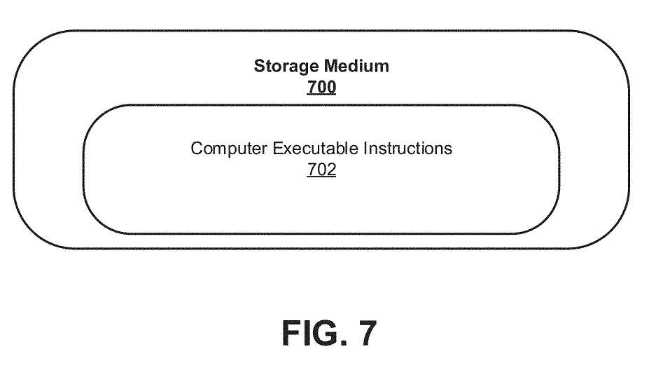

FIG. 7 illustrates an embodiment of a storage medium 700. The storage medium 700 may comprise an article of manufacture. In some examples, the storage medium 700 may include any non-transitory computer readable medium or machine readable medium, such as an optical, magnetic or semiconductor storage. The storage medium 700 may store various types of computer executable instructions e.g., 702). For example, the storage medium 700 may store various types of computer executable instructions to implement the dynamic one or more light beam, and associated one or more pixel, compensation techniques described herein. The storage medium 700 may be coupled to one or more of the systems 100, 1000, 450, 550 and 600. For example, when coupled to the one or more systems, the computer executable instructions 702 may be executed by the one or more systems to aid in performing one or more techniques described herein (e.g., gaze detection aided by reflected infrared beams and/or power savings techniques based on gaze detection). Furthermore, the storage medium 700 may store other information related to the controlling of power and/or other operational functionalities associated with HWDs.

Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

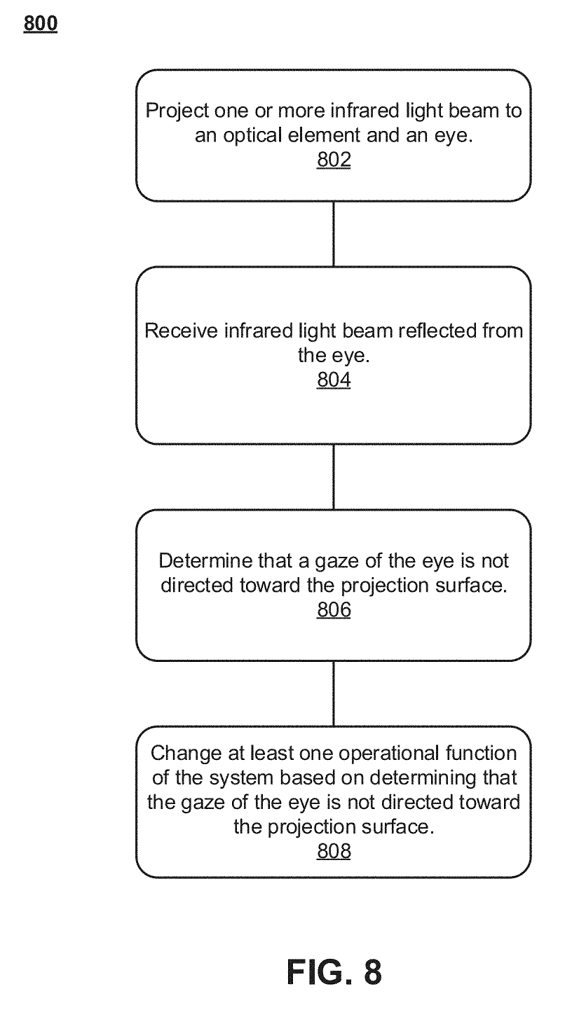

FIG. 8 illustrates a logic flow 800. In one implementation, the storage medium 700 may store various types of computer executable instructions related to logic flow 800. For example, the computer executable instructions 702 may be used to implement the logic flow 800. In general, the computer executable instructions 702 may be provided to implement the techniques and logic for generating infrared light beams and receiving reflected light beams described in the foregoing and hereinafter. Furthermore, the computer executable instructions 702 may be provided to implement the techniques and logic for controlling one or more element of the one or more system, described herein, based on eye gaze information ascertained from reflected infrared light beams.

At block 802, a system, such as the system 100, system 1000, system 450, system 550 and/or system 600, projects one or more infrared light beam (e.g., infrared light beam 458 and/or infrared light beam 464) to an optical element (e.g., optical element 456). The optical element directs the one or more infrared light beam to a projection surface (e.g., projection surface 400). The projection surface may include an HOE (e.g., HOE 401). The projection surface may reflect the infrared light beam to an eye. (e.g., eye 500). More specifically, the projection surface may be manufactured to include one or more surface or layer that reflects infrared light. Furthermore, the projection surface may be manufactured to include one or more surface or layer that reflects infrared light and visible light.

At block 804, the one or more infrared light beam is reflected (e.g., reflected infrared light beam 460 and/or 464) off a surface of the eye 500, or a surface in proximity to the eye 500. The reflected light beam is received by one or more of the projection surface, optical element, and/or an infrared light beam receiver (e.g., infrared light beam receiver 454).

At block 806, it is determined that a gaze of the eye is not directed toward the projection surface. In one implementation, a light intensity of the reflected light beam is used to determine that the gaze of the eye is not directed toward the projection surface.

At block 808, at least one operational function of the system is changed, modified, altered, adapted and/or influenced based on determining that the gaze of the eye is not directed toward the projection surface. In one implementation, a power supply function of the system is adapted based on determining that the gaze of the eye is not directed toward the projection surface.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Example 1. An apparatus, comprising an infrared light beam emitter to emit at least one infrared light beam; and an holographic optical element (HOE) to reflect the at least one infrared light beam toward an eye.

Example 2. The apparatus according to Example 1, wherein the HOE is comprised in or on a projection surface.

Example 3. The apparatus according to Example 1, further comprising a visible light beam emitter to emit at least one visible light beam, the HOE to reflect the at least one visible light beam toward an eye.

Example 4. The apparatus according to Example 1, wherein the HOE includes a first layer and a second layer, the first layer to reflect infrared light and the second layer to reflect visible light.

Example 5. The apparatus according to Example 4, wherein the first and second layers are situated in a stacked arrangement.

Example 6. The apparatus according to Example 4, wherein the first and second layers are situated in a side-by-side arrangement.

Example 7. The apparatus according to Example 4, wherein the first layer and the second layer are photopolymer material.

Example 8. The apparatus according to Example 1, wherein the HOE includes a first layer, the first layer to reflect infrared light and further to reflect visible light.

Example 9. The apparatus according to Example 1, further comprising logic to ascertain gaze information associated with the eye based on a light intensity of infrared light reflected from the eye, the logic further to adjust a functionality of the apparatus based on the ascertained gaze information associated with the eye.

Example 10. A method, comprising emitting at least one infrared light beam; and reflecting, from a holographic optical element (HOE), the at least one infrared light beam toward an eye.

Example 11. The method according to Example 10, wherein the HOE includes a first layer and a second layer, the first layer to reflect infrared light and the second layer to reflect visible light.

Example 12. The method according to Example 11, wherein the first and second layers are situated in a stacked arrangement.

Example 13. The method according to Example 11, wherein the first and second layers are situated in a side-by-side arrangement.

Example 14. The method according to Example 11, wherein the first layer and the second layer are photopolymer material.

Example 15. The method according to Example 10, wherein the HOE includes a first layer, the first layer to reflect infrared light and further to reflect visible light.

Example 16. An apparatus, comprising: a light source to emit one or more light beam; and a projection surface comprising a holographic optical element (HOE) to reflect infrared light and further to reflect visible light.

Example 17. The apparatus according to Example 16, wherein the one or more light beam includes an infrared light beam and a visible light beam, the infrared light beam to reflect off the HOE toward an eye and the visible light beam to reflect off the HOE toward the eye.

Example 18. The apparatus according to Example 16, wherein the HOE includes a first layer to reflect the infrared light and a second layer to reflect the visible light.

Example 19. The apparatus according to Example 16, wherein the HOE includes a single layer to reflect the infrared light and the visible light.

Example 20. The apparatus according to Example 16, wherein the HOE includes a first layer to reflect the infrared light and a second layer to reflect the visible light, the first layer and the second layer in a stacked arrangement or a side-by-side arrangement.

Example 21. A holographic optical element (HOE), comprising: a first layer to reflect infrared light; and a second layer to reflect visible light.

Example 22. The HOE according to Example 21, wherein the first and second layer are disposed in a side-by-side arrangement.

Example 23. The HOE according to Example 21, wherein the first and second layer are disposed in a stacked arrangement.

Example 24. The HOE according to Example 21, wherein the HOE is integrated in a head worn display (HWD) system.

Example 25. The HOE according to Example 21, wherein the HOE is integrated in a projection surface of a head worn display (HWD) system.

Example 26. An apparatus, comprising means to emit at least one infrared light beam; and an holographic optical element (HOE) to reflect the at least one infrared light beam toward an eye.

Example 27. The apparatus according to Example 26, wherein the HOE is comprised in or on a projection surface.

Example 28. The apparatus according to Example 26, further comprising means to emit at least one visible light beam, the HOE to reflect the at least one visible light beam toward an eye.

Example 29. The apparatus according to Example 26, wherein the HOE includes a first layer and a second layer, the first layer to reflect infrared light and the second layer to reflect visible light.

Example 30. The apparatus according to Example 29, wherein the first and second layers are situated in a stacked arrangement.

Example 31. The apparatus according to Example 29, wherein the first and second layers are situated in a side-by-side arrangement.

Example 32. The apparatus according to Example 29, wherein the first layer and the second layer are photopolymer material.

Example 33. The apparatus according to Example 26, wherein the HOE includes a first layer, the first layer to reflect infrared light and further to reflect visible light.

Example 34. The apparatus according to Example 26, further comprising means to ascertain gaze information associated with the eye based on a light intensity of infrared light reflected from the eye, the means to ascertain gaze information further to adjust a functionality of the apparatus based on the ascertained gaze information associated with the eye.

Example 35. A holographic optical element (HOE), comprising: means to reflect infrared light; and means to reflect visible light.

Example 36. The HOE according to Example 35, wherein the means to reflect infrared light and means to reflect visible light are disposed in a side-by-side arrangement.

Example 37. The HOE according to Example 35, wherein the means to reflect infrared light and means to reflect visible light are disposed in a stacked arrangement.

Example 38. The HOE according to Example 35, wherein the HOE is integrated in a head worn display (HWD) system.

Example 39. The HOE according to Example 35, wherein the HOE is integrated in a projection surface of a head worn display (HWD) system.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus, comprising:
an infrared light beam emitter to emit at least one infrared light beam; and
an holographic optical element (HOE) to reflect the at least one infrared light beam toward an eye.

2. The apparatus according to claim 1, wherein the HOE is comprised in or on a projection surface.

3. The apparatus according to claim 1, further comprising a visible light beam emitter to emit at least one visible light beam, the HOE to reflect the at least one visible light beam toward an eye.

4. The apparatus according to claim 1, wherein the HOE includes a first layer and a second layer, the first layer to reflect infrared light and the second layer to reflect visible light.

5. The apparatus according to claim 4, wherein the first and second layers are situated in a stacked arrangement.

6. The apparatus according to claim 4, wherein the first and second layers are situated in a side-by-side arrangement.

7. The apparatus according to claim 4, wherein the first layer and the second layer are photopolymer material.

8. The apparatus according to claim 1, wherein the HOE includes a first layer, the first layer to reflect infrared light and further to reflect visible light.

9. The apparatus according to claim 1, further comprising logic to ascertain gaze information associated with the eye based on a light intensity of infrared light reflected from the eye, the logic further to adjust a functionality of the apparatus based on the ascertained gaze information associated with the eye.

10. A method, comprising:
emitting at least one infrared light beam; and
reflecting, from a holographic optical element (HOE), the at least one infrared light beam toward an eye.

11. The method according to claim 10, wherein the HOE includes a first layer and a second layer, the first layer to reflect infrared light and the second layer to reflect visible light.

12. The method according to claim 11, wherein the first and second layers are situated in a stacked arrangement.

13. The method according to claim 11, wherein the first and second layers are situated in a side-by-side arrangement.

14. The method according to claim 11, wherein the first layer and the second layer are photopolymer material.

15. The method according to claim 10, wherein the HOE includes a first layer, the first layer to reflect infrared light and further to reflect visible light.

16. An apparatus, comprising:
a light source to emit one or more light beam; and
a projection surface comprising a holographic optical element (HOE) to reflect infrared light and further to reflect visible light.

17. The apparatus according to claim 16, wherein the one or more light beam includes an infrared light beam and a visible light beam, the infrared light beam to reflect off the HOE toward an eye and the visible light beam to reflect off the HOE toward the eye.

18. The apparatus according to claim 16, wherein the HOE includes a first layer to reflect the infrared light and a second layer to reflect the visible light.

19. The apparatus according to claim 16, wherein the HOE includes a single layer to reflect the infrared light and the visible light.

20. The apparatus according to claim 16, wherein the HOE includes a first layer to reflect the infrared light and a second layer to reflect the visible light, the first layer and the second layer in a stacked arrangement or a side-by-side arrangement.

21. A holographic optical element (HOE), comprising:
a first layer to reflect infrared light; and
a second layer to reflect visible light.

22. The HOE according to claim 21, wherein the first and second layer are disposed in a side-by-side arrangement.

23. The HOE according to claim 21, wherein the first and second layer are disposed in a stacked arrangement.

24. The HOE according to claim 21, wherein the HOE is integrated in a head worn display (HWD) system.

25. The HOE according to claim 21, wherein the HOE is integrated in a projection surface of a head worn display (HWD) system.
